(19) United States
(12) Patent Application Publication
(10) Pub. No.: US 2003/0136590 A1
(43) Pub. Date: Jul. 24, 2003

(54) Programmable device with a gravimetric measuring instrument, method of programming such a device, and software for executing this method

(75) Inventor: Siegfried Gluvakov, Bubikon (CH)

Correspondence Address: BURNS, DOANE, SWECKER & MATHIS, L.L.P., P.O. Box 1404, Alexandria, VA, 22313-1404, US

(73) Assignee: Mettler-Toledo GmbH

(21) Appl. No.: 10/342,176

(22) Filed: Jan. 15, 2003

(30) Foreign Application Priority Data
Jan. 18, 2002 (EP) 02100040.1

(51) Int. Cl. G01G 13/18

(52) U.S. Cl. 177/105

(57) ABSTRACT

The present invention is directed to a system with a gravimetric weighing instrument, a network interface, a network, and a computer, wherein the gravimetric weighing instrument can be connected via the network interface to the network. Executable on the computer is a browser application, and the network interface makes available a command application which, via the browser application, causes the representation on the computer of an input mask. Via the input mask on the computer, a program for automatic use of the gravimetric weighing instrument can be defined, the program being executable by the gravimetric weighing instrument.

### RELATED APPLICATIONS

The present application claims priority under 35 U.S.C. § 119 to European Patent Application No. 02100040.1 filed Jan. 18, 2002, the disclosure of which is hereby incorporated by reference in its entirety.

### BACKGROUND

1. Field

The invention relates to devices with a gravimetric measuring instrument. Particularly affected are electronic balances or scales which can be connected via a network connection to a network and a computer.

2. Background Information

Normally, balances or scales, as they are used in research, development, and production, are realized as independent devices which require only an electric power supply to be capable of use.

More recently, there are electronic balances or scales which have a network interface and can be operated in a network. Normally, for this purpose the balance or scale is fitted with a simple RS-232 interface. The possibilities afforded by connection to a network are not fully exploited by far. However, applications are now being developed which increasingly make use of connection to a network.

### SUMMARY

An object of the present invention is to provide a method which allows balances, scales, and other instruments and devices with at least one weighing cell to be used more flexibly.

A further object of the invention is to individualize balances, scales, and other instruments and devices with at least one weighing cell, meaning to operate them in such manner that they meet the momentary requirements of a user.

An advantage of the invention is that it can improve the reproducibility of measurement procedures and/or analytical procedures.

A further advantage of the invention is that it can not only define weighing tasks in the form of programs, but can also enable complete solutions to be realized which can serve as supporting tools in the laboratory, and also be a component of research, development, and quality control processes.

### BRIEF DESCRIPTION OF THE DRAWINGS

Further details and advantages of the invention are comprehensively described below by reference to various exemplary embodiments, and by reference to the drawings which form an integral part of the disclosure of the present invention. According to the invention, there are shown in:

FIG. 1 a diagrammatical representation of a first exemplary system;

FIG. 2 a diagrammatical flow chart of a first exemplary method;

FIG. 3 a diagrammatical representation of an exemplary input mask;

FIG. 4 a diagrammatical representation of a further exemplary system;

FIG. 5 a diagrammatical representation of a further exemplary system;

FIG. 6 a diagrammatical representation of an exemplary network interface; and

FIG. 7 a diagrammatical representation of an exemplary balance.

### DETAILED DESCRIPTION OF THE PREFERRED EMBODIMENTS

The invention can be used on the most diverse measuring instruments, especially on laboratory instruments with at least one gravimetric measuring instrument (e.g. in the form of a weighing cell). These include, among others, dryers and comparators, as well as other instruments such as weighing modules in production lines. For the sake of simplicity, the invention is described below mainly in relation to electronic balances, but this is not to be interpreted as a restriction.

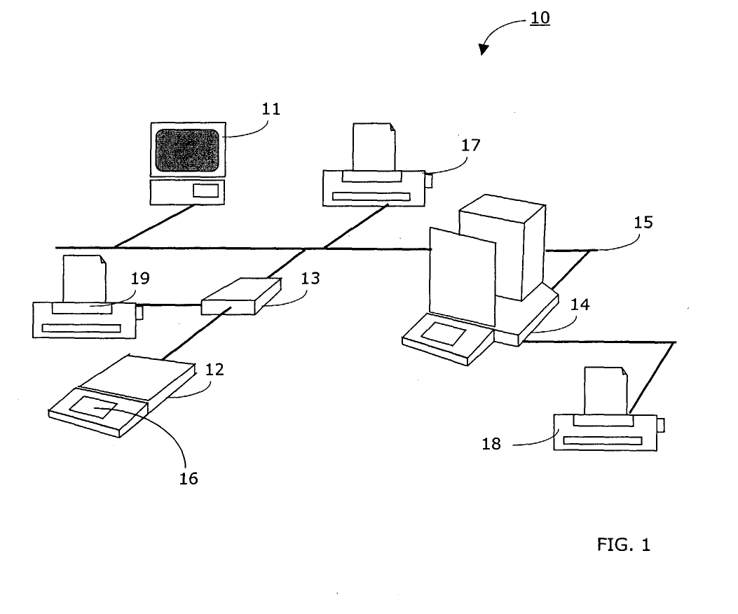

A first embodiment of the invention can be seen in the diagrammatic representation in FIG. 1. A system 10 is shown, which has two electronic balances 12 and 14 (e.g. analytical balances, precision balances, comparators, microbalances, or the like). The balance 12 is connected via an external network interface 13 to a network 15 and a computer 11. The balance 14 possesses a built-in network interface (not shown in FIG. 1), which can be constructed in similar manner to the network interface 13. The computer 11, the balances 12, 14, and the network interfaces are realized in such manner that establishment of a communication connection between the balances 12, 14 and the computer 11 is possible. On the computer 11 it is possible to run a browser application. For this purpose, it is possible to use either a standard browser (e.g. Netscape Navigator or Microsoft Internet Explorer) or a specially installed browser. The network interface 13 is realized in such manner as to be able to make available a command application. This command application is transmitted by the network interface 13 to the computer 11, or loaded from the computer 11, so as to cause the browser application to produce on the computer 11 the representation of an input mask. The input mask is so designed and supported by software, that via the computer 11—for example by using the computer keyboard or a computer mouse (neither of which is shown in FIG. 1)—a program for automatic use of one of the balances 12 or 14 can be defined. Once definition of the program is complete, the program can be made available by the computer 11 via the network 15 and the network interface 13. This takes place so that the program can be executed by the respective balance 12 or 14. Various peripheral devices can be connected to the system 10. In FIG. 1, three printers 17, 18, and 19 are components of the system 10. The printer 17 is a network printer, which is connected directly to the network. A further printer 18 is attached to the balance 14, and the printer 19 is controlled from the network interface 13.

A further embodiment of the invention is described below, without reference to any of the figures. This is a system which has at least one weighing cell. The system is connected via an external or internal data interface to a computer. The computer and the system are realized in such manner that a communication connection can be established between the two of them. A browser application can be run on the computer. A command application is employed. This command application can, for example, be transmitted from the data interface to the computer, or loaded from the computer. The browser causes an input mask to be represented on the computer. The input mask is preferably designed and supported by software in such manner that a program for automatic use of the weighing cell can be defined via the computer. Once definition of the program is complete, the program can be made available by the computer. This takes place in such manner that the program can be executed by the weighing cell.

The term “program” is to be understood as meaning a form of representation which describes one or more steps or actions capable of being executed by an electronic balance. The language in which the program is defined is irrelevant. The program can, for example, be described in a form of script, which is then translated into a form of machine language or suchlike, before being executed step-by-step by the balance.

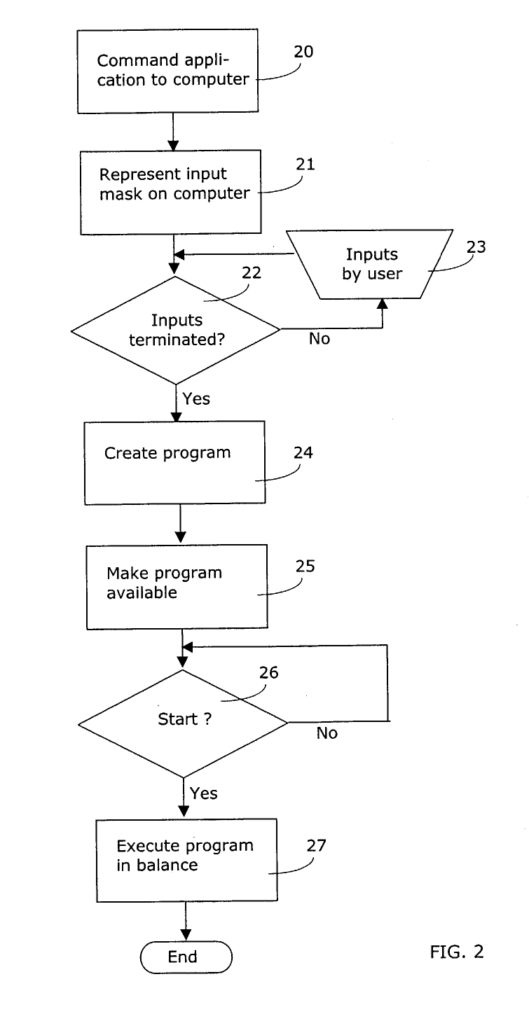

According to the invention, a method can proceed with, for example, the steps described below. The object of the method is to define a program for automatic use of an electronic balance 12 or 14, either with or without peripheral devices, which can be in communication connection with a computer 11 via an external or internal network interface and a network 15. This being so, steps including the following are executed as represented in the flow chart shown in FIG. 2:

Step 1 (Box 20): Transmit a command application from the network interface 13 to the computer 11. The command application is specific to the balance, i.e. the command application is specially adapted to the sort, and/or type, of balance. This is advisable, since there are various sorts/types of balance 12, 14, which are characterized by different specifications. There are two different methods. According to the first method, the network interface 13, or the balance 14 with built-in network interface, is addressed directly by the computer 11. This can take place, for example, by use of an identification number (ID), address (e.g. an IP address), domain name (e.g. within a local network), or suchlike, each balance 12, 14, having its own domain name and address, and being addressable via the network 15. The network interface 13 of the addressed balance 12 or 14 thereupon sends the command application via the network 15 to the computer 11.

Step 2 (Box 21): Represent an input mask on the Computer 11. This takes place with the aid of the command application specific to the balance. Preferably, the input mask is processed by a browser, which can be installed on the computer 11. If the command application is an applet, for example a so-called Java applet, the browser must be capable of processing such applets. Depending on the browser, this requires, for example, a corresponding plug-in. Other command applications can, however, be used, provided there is assurance that an input mask can be represented on the monitor of the computer 11.

Step 3 (Boxes 22, 23, 24): Create a desired program by means of the computer 11. For this purpose, the user can enter information (e.g. data or parameters) into the input mask on the computer 11, or make a selection in the input mask by clicking. To make this possible, buttons (radio buttons) or selection lists (e.g. pull-down menus) can be provided in the input mask. Shown in FIG. 2 is a flow chart, in which the program is only created (Box 24) after the input through the input mask is complete. However, it is also possible to generate the corresponding line(s) of the program during or after each input or selection. Both embodiments of this alternative have the advantage that the program being created can be represented in a window (e.g. in ASCII format). Thus, the user can at any time check the program being created, and correct it if necessary.

Step 4 (Box 24): When definition of the program is complete, the program can be made available via the network 15 and the network interface 13. The program can be stored either in the network interface 13, or in the balance 12 or 14, before it is subsequently executed. The program can, for example, be stored in the form of an input file. It can also be written line by line into a sort of database, possibly in pre-formatted or adapted form.

Step 5 (Box 27): Automatic step-by-step execution of the created program in the balance 12. For this purpose, the balance contains a control application. Now, for example after a start command has been given by a keystroke on the balance 12 (Box 26), the pre-defined and stored program is executed step-by-step by the control application. The control application can also be implemented in some other place, especially in the computer if the balance is operated remotely, but implementation in the balance is preferable. Specific attention is drawn to the fact that the automatic step-by-step execution of the pre-defined and stored program can also include steps which require action from outside, for example by an operating person or a robot. “Automatic” is therefore not to be understood exclusively in the sense of “without any interaction with the environment”, although this can be the case.

It is self-evident that before, during, or after the said five steps, additional steps can be executed.

The command application according to the invention can have one or more of the following characteristics:

Support for representation of an input mask on the monitor of a computer;

Support for creation of a program, preferably in the form of a script;

Editing and/or storing and/or loading programs from any location (e.g. a computer at another location separated by a network);

Starting and/or stopping a programmed procedure;

Storage and/or output (e.g. representation) of captured data on a computer; etc.

In a further embodiment of the invention, the network 15 of the system is a standardized bus. In this case, a standard communication protocol can be used for communication between network interface and computer. This facilitates implementation of the invention, since not only can standard components be used (e.g. as bus driver) but also standard software. Preferably, use is made of an Ethernet bus and an IP-based protocol. The bus can be realized with either cable or glass fiber, or as a wireless bus. A very suitable method, for example, is wireless communication with Bluetooth.

The network interface 13 preferably contains an application similar to a web server, to be able to make the command application available when requested to do so by the computer 11. This application similar to a web server can, for example, be realized in such manner that the network interface 13 can be addressed by the computer 11 by means of a uniform resource locator (URL).

The present invention is especially suitable for defining by means of the program a measurement procedure, or analytical procedure, which is to be performed on the balance. The procedure can be, for example, an interactive procedure in which the measurement procedure begins after a start key is pressed. On the display 16 of the balance 12, a respective accompanying text or pictogram (for example, supported with acoustic and/or optical signals) can be displayed. Thus, for example, the user can be prompted by displayed text to place the substance to be weighed on the balance.

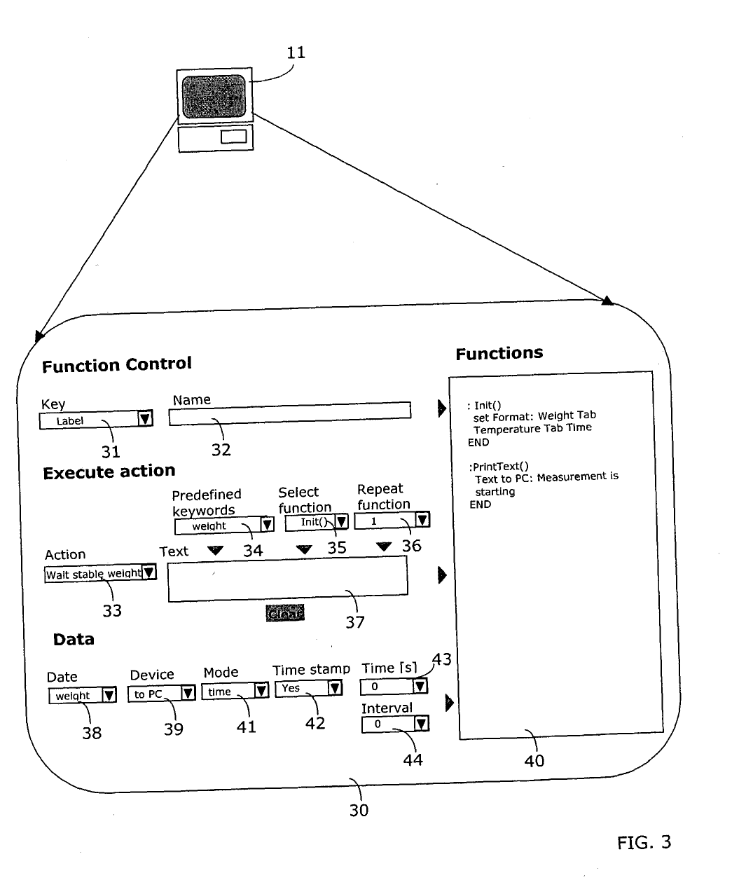

According to a special embodiment of the invention, the program is described in a higher-level programming language, preferably in a form of script which is readable for the user. In FIG. 3, an example is shown of an input mask 30 which is displayed on the monitor of a computer 11. In the example shown, to support creation of the program, various tools are provided in the form of selection lists 31, 33, 34, 35, 36, 38, 39, 41, 42, 43, 44 with list buttons (shown as rectangles and triangles) and input and/or display windows 32, 37, 40. In the display window 40 on the right-hand side of the input mask 30, the program which is being created is shown. Under the heading “Function control”, the user can define his/her own functions. The user can, for example, select in the selection list 31 a characteristic “Label”, and then in the input window 32 assign a name to the function. The function to be executed can be defined under the heading “Execute action”. For this purpose too, functions already available are offered in a selection list 33. These functions which are already available can serve as modules. The user can also define an action directly in the display and input window 37. With the aid of a range of keywords and functions offered in the three selection lists 34, 35, and 36, the user can specify an action. How often an action is to be repeated is specified by selecting a corresponding number in the selection list 36. In this manner, loops can be programmed which must be executed several times over. Under the heading “Data”, the data format or the data output, for example, can be specified. Here, too, various selection lists 38, 39, 41-44, are provided to support operation by the user.

According to the invention, the following data, for example, can be determined and output: absolute weight, relative weight, temperature, temperature difference, time, date, pressure, air humidity, etc. Self-evidently, which of these data items are actually available depends on the type and equipment of the balance being used, and on the command application being used.

It is also possible to extend the system in such manner as to make it possible to edit directly in the display window 40, which thereby becomes a display and input window. However, such editing requires some knowledge of the syntax of the programming language which is used. To avoid errors, a debugger can be provided which checks the program after it has been specified, to detect programming errors and indicate them.

By means of an input mask 30, such as that shown in FIG. 3 for example, user-friendly definition of the program is made possible, for example. The user needs only a little basic knowledge to be able to program via the computer a measurement procedure for an electronic balance, for example.

Preferably, templates (standard scripts) can be provided as a sort of example. The user can then load a suitable template into the computer, and have the template displayed in the window 40 of the input mask. If the template meets the user's requirements, the user can transmit the template via the network to the balance. Otherwise, the user can make changes to the program before then transmitting it to the balance.

In another embodiment, the network interface is realized as a relatively simple and inexpensive device, which has only the hardware needed for communication with the computer and the balance (e.g. Vis an RS-232 interface). The network interface also contains the command application.

According to a further embodiment of the invention, the program can also be assembled from individual modules (routines). Some examples of such modules are given below. This list makes no claim to be exhaustive, and is for explanatory purposes only:

Open door (the door of the balance is opened automatically);

Load the balance (a prompt, for example as displayed text, is issued to load the balance);

“Wait stable weight” (this is a routine which waits until the balance becomes stable);

Open or close draft shield;

Raise or lower lift;

Display text;

Delete display;

Output text on printer;

Transmit text to computer;

Open dialog;

Define data format;

And so forth.

If the balance has a graphics display, the user can, for example, personalize existing programs by including a company logo, the name of the present user, user-specific definitions, or suchlike, so that these can then be displayed on the respective balance.

The invention not only provides the possibility of specifying the sequence in a procedure (e.g. a measurement procedure). Other applications can also be defined, which, for example, run in the balance in parallel with a measuring operation. A possibility is specification of a monitoring function (reporting function), which transmits particular values to the computer, and/or saves the values along with time stamp(s), and/or prints the values out.

Execution of a selected program is made possible by the control application, which is preferably implemented in the balance. The control application is usually designed so that it writes a transmitted program to memory before the program is taken from there and executed. In a memory in the balance a small number of routines can be permanently stored, for example for demonstration purposes. The control application can read the individual lines of the specified program from a memory and execute them step-by-step. For the control application, a form of interpreter, for example, can be used.

The control application can be realized as a form of player, which when started by a start button on the balance (or on the computer) executes the program step-by-step. In addition to the start button, further operating elements (for example, a pause button) can be provided.

The control application can be constructed in such manner that it is possible to capture measurement values determined by the balance, and/or to transmit measurement values to the computer, and/or to address a peripheral device (e.g. a printer or a thermometer).

The control application according to the invention can have one or more of the following characteristics:

Storing the program;

Executing the program;

Recording measurement values;

Transmitting determined measurement values from the balance to a computer, or peripheral device, which is accessible either via the network or directly from the balance;

Controlling peripheral devices of the balance;

And so forth.

In a further embodiment according to the invention, the balance can be started or stopped from the computer. Preferably, this is realized by the command application, which is in communication with the balance via the network and the network interface.

Preferably, the control application and the command application are matched to each other to ensure trouble-free functioning. Also with a good match, for example by use of a command application specifically for balances and exactly matched to the balance, the full functionality of a balance can be used.

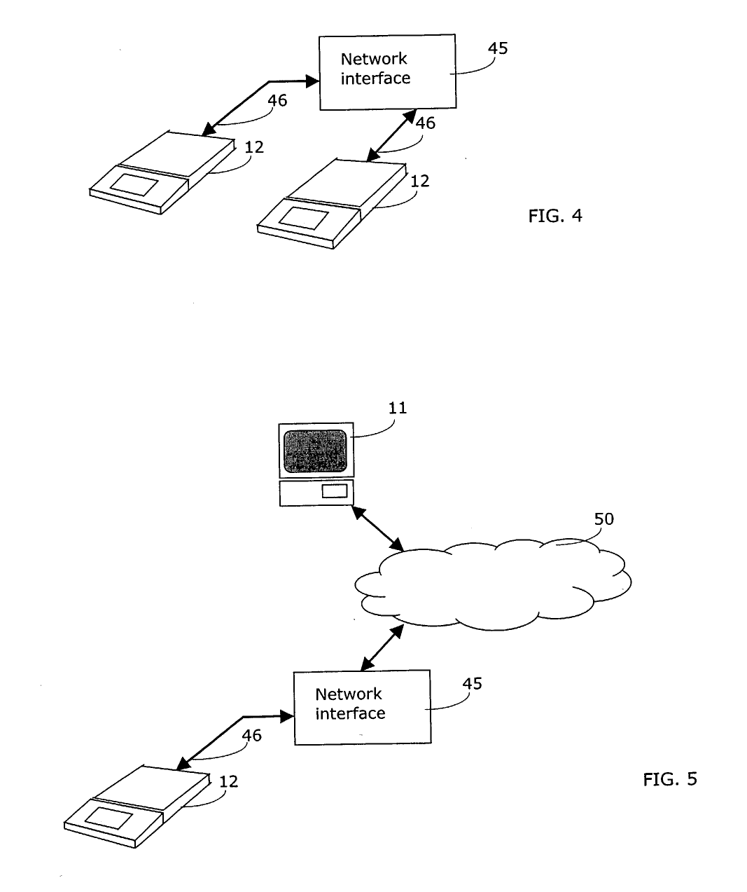

As shown in FIG. 4, via a network interface 45 several balances 12 can be connected. For this purpose, the network interface 45 can be equipped with, for example, two RS-232 sockets, to allow creation of RS-232 connections 46 between the balances 12 and the network interface 45.

A network interface according to the invention can also have, as well as the interface or interfaces to the balance or instruments, one or more interfaces to peripheral devices. Thus, for example, the following peripheral devices can be readily connected to a balance: printers, temperature- and/or pressure-measuring instruments, barcode readers, robots, automated laboratory devices, weighing lifts, relays, etc.

In a further embodiment, a balance 12 can be connected via the network interface 45 to a large network 50, for example the Internet, as shown very diagrammatically in FIG. 5. Then, at another point of the large network 50, a computer 11 is connected. In the case of such a configuration, it is important to give consideration to security aspects, to prevent unauthorized persons from controlling the balance 12 or manipulating the programming of the balance 12. Known solutions can be employed to guarantee the necessary security.

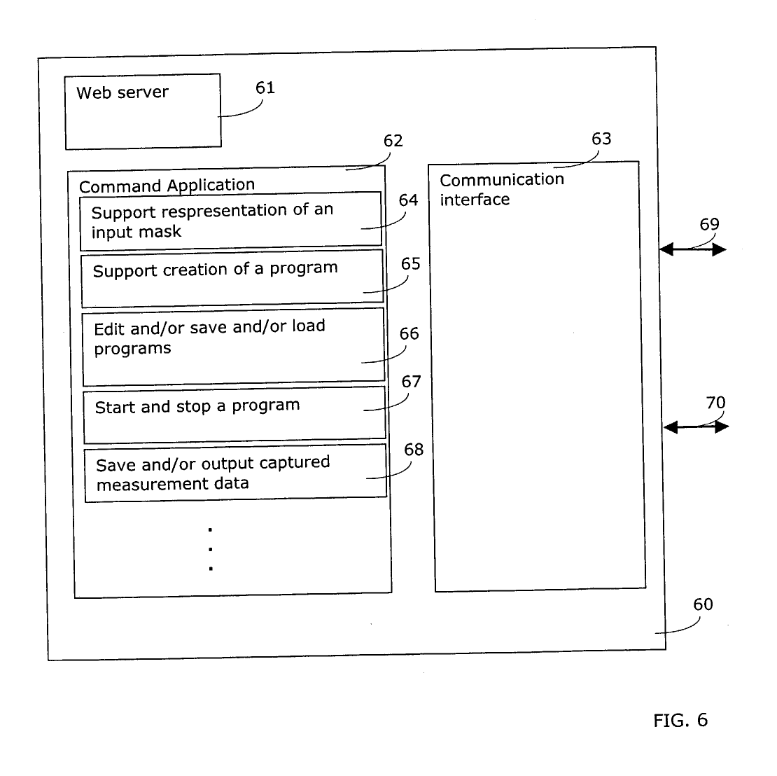

The example of a network interface 60 with the various software modules 61, 62, and 63 is shown schematically in FIG. 6. It should be noted that in FIG. 6 not the hardware, but only the software modules, are shown. So that the network interface can be addressed from a remote computer, it has a form of web server 61. Via the web server 61, the command application 62 can be uploaded to the computer, for example. In the example shown, the command application 62 comprises several modules 64-68. Each of these modules supports a particular functionality. By means of module 64, the browser in the computer is supported with creating the input mask. Module 65 supports the computer with creating the program, and module 66 allows, for example, editing and/or storing and/or loading of programs. By means of module 67, a program can be started or stopped. To store and/or output the captured measurement data, the module 68 can be used. The command application 62 can be augmented with further modules, as indicated by the dots in FIG. 6. As a third software module, the network interface 60 has a software which serves as communication interface 63. By means of this interface 63, the main procedures for establishing, terminating, and using a communication connection are handled. The network interface 60 has a first connection 70 to a balance, and a second connection 69 to a network. Not all modules 64-68 need be present. Fewer modules, and/or different modules, can also be provided.

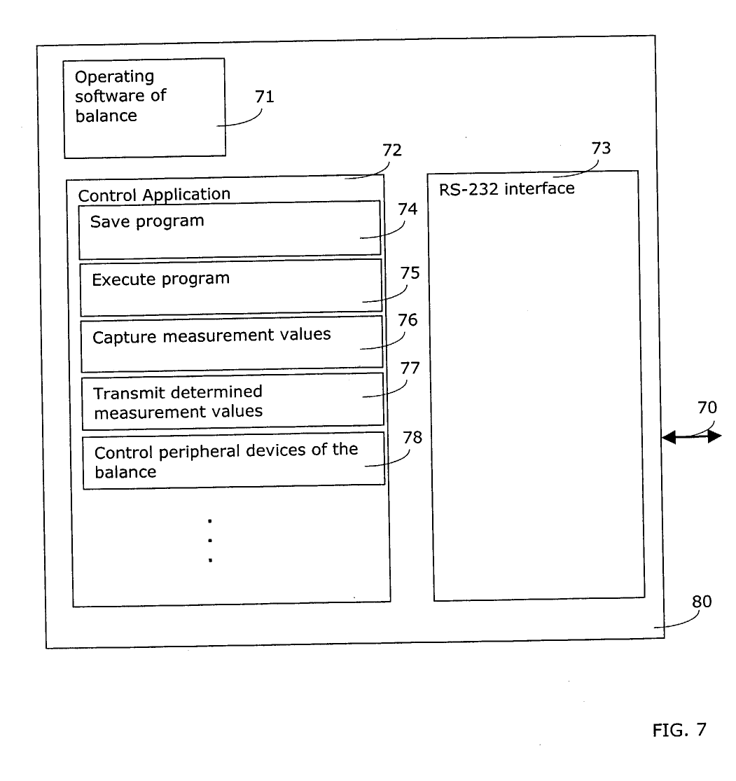

The example of a balance 80 is shown in FIG. 7, but only the main software modules 71, 72, and 73 are shown. Most electronic balances 80 contain an operating software 71, to control and monitor the actual procedures inside the balance 80. In addition, the balance 80 has an interface to a network interface. The interface is supported by an RS-232 interface software 73. The RS-232 interface to the network interface is indicated as a double-headed arrow, 70. According to the invention, the balance 80 also contains a control application 72. In the example shown, the control application has several modules 74-78 and can be expanded if necessary. The first module 74 is designed for storing the program. Execution of the program takes place with support of the second module 75, while module 76 records the measurement values. If desired, the measurement values determined are transmitted by the module 77 to, for example, a remote computer. If the balance 80 is equipped with, or connected to, peripheral devices, the module 78 can be deployed. Not all modules 74-78 need be present. Fewer modules, and/or different modules, can also be provided.

An advantage of the invention is that the user or customer can define a weighing or analysis application. According to the invention, users or customers can, for example, define their own measuring standards.

Users or customers can create their own applications without special knowledge of programming. Previously saved applications (or parts of applications) can be re-used as modules for the creation of a new application. For example, via a network server, various applications can be made available for later use.

A further advantage is that measurement values from the balance can be transmitted to any other location in the network. For example, the result of an analysis can be transmitted to the computer at the office workplace of a laboratory technician. The results can then be processed further at that workplace.

Measurements can also be monitored from any location. This function can be deployed, for example, for training courses.

Applications in a balance according to the invention are dynamic, since they are controlled by the procedure loaded from outside.

Any combinations of the embodiments shown and/or described belong within the scope of the present invention, even if these combinations are not explicitly presented. The reference numbers in all figures always designate the same elements, even if these are not always explained in detail.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

1. System comprising:
at least one gravimetric measuring instrument, at least one data interface, and a computer, wherein
a. the measuring instrument is connected via the data interface to the computer, for establishing communication between the measuring instrument and the computer;
b. the computer includes an executable browser application;
c. the computer includes a command application for representation of an input mask;
d. a program defined via the input mask on the computer for automatic use of the measuring instrument is provided;
e. the program is made available by the computer; and
f. the program is executable by the measuring instrument.

2. System according to claim 1 with a network, the data interface being a network interface, wherein:
a. the measuring instrument is connected via the network interface and the network to the computer, to make available the communication connection between the measuring instrument and the computer;
b. the command application is made available by the network or via the network interface; and
c. the program is made available by the computer via the network and the network interface.

3. System according to claim 1, wherein for communication with the computer a standard IP-based communication protocol is used.

4. System according to claim 1, wherein the command application is realized as an application or as an applet.

5. System according to claim 2, wherein the network interface contains an application similar to a web server, to make the command application available on request from the computer.

6. System according to claim 1, wherein the program defines a measurement procedure which can be executed on the measuring instrument.

7. System according to claim 1, wherein the program is described in a programming language, in a form of script which is readable for users.

8. System according to claim 1, wherein a user-friendly definition of the program is made possible by the input mask.

9. System according to claim 1, wherein in the measuring instrument there is a control application, by means of which execution of the program by the measuring instrument can be controlled.

10. System according to claim 9, wherein the control application makes it possible to:
record measurement values which have been determined by the measuring instrument; and/or
transmit measurement values to the computer; and/or
control a peripheral device.

11. System according to claim 1, wherein the command application makes starting and/or stopping of the program via the network possible.

12. System according to claim 1, wherein the measuring instrument is a weighing cell.

13. System according to claim 12, wherein the weighing cell is a component of a balance or scale, a dryer, a comparator, or another instrument.

14. Method of specifying and executing step-by-step a program for automated use of at least one gravimetric measuring instrument, which is in communication connection with a computer via a data interface, the method comprising:
a. transmitting a command application to the computer, the command application being specific to the measuring instrument;
b. representing, with the aid of the command application, an input mask on the computer;
c. creating the program by means of the computer, depending on inputs which are made through the input mask;
d. making the created program available via the data interface;
e. automatically executing the program step-by-step in the measuring instrument.

15. Method according to claim 14, wherein the communication connection is via a network, and wherein the command application is transmitted to the computer, and the created program made available, via the network.

16. Method according to claim 15 wherein, before execution of the transmitting, the computer addresses the measuring instrument through the network using an identification, which includes an IP address, a domain name, or an ID code.

17. Method according to claim 15, wherein a network interface is present, and the created program, before being automatically executed step-by-step, is written to an internal database of the network interface.

18. Method according to one of claim 14, wherein measurement values which were determined during the executing of the program are made available for further use.

19. Method according to claim 14, wherein during the executing of the program, a reporting or monitoring function runs on the measuring instrument to transmit information to the computer.

20. Method according to claim 14, wherein the measuring instrument is a weighing cell.

21. Method according to claim 20, wherein the weighing cell is a component of a balance or scale, a dryer, a comparator, or another instrument

22. Software for use in a system with at least one gravimetric measuring instrument, at least one data interface, and a computer, wherein the measuring instrument is in communication connection with the computer via the interface, and the software executes a process on the computer, the process comprising:
supporting a representation of an input mask on a monitor which is connected to the computer;
supporting creation of a program in the form of a script; and
editing and/or saving and/or loading programs.

23. Software according to claim 22, wherein the data interface is a network interface, and wherein the system includes a network, and the communication connection between the computer and the measuring instrument is via the network interface and the network.

24. Software according to claim 22, wherein at least one of the following steps is executed:
starting and/or stopping a programmed procedure; and
storing and/or outputting captured data on the computer.

25. Software according to claim 22, wherein the process is an application or an applet.

26. Software according to claim 22, wherein the measuring instrument is a weighing cell.

27. Software according to claim 26, wherein the weighing cell is a component of a balance or scale, a dryer, a comparator, or another instrument.

28. Software according to claim 22, wherein at least one of the following steps is executed:
transmitting determined measurement values from the measuring instrument to a computer or a peripheral device; and
controlling peripheral devices of the measuring instrument.

29. A data interface configured with software according to claim 22.

30. A programmable gravimetric measuring instrument with software according to claim 22.

31. A programmable gravimetric measuring instrument with a data interface according to claim 29.
